(19) United States
(12) Patent Application Publication
(10) Pub. No.: US 2021/0369410 A1
(43) Pub. Date: Dec. 2, 2021

(54) ROOT CANAL FILLING DEVICE

(71) Applicant: Yongsik CHO, Goyang (KR)

(72) Inventor: Yongsik CHO, Goyang (KR)

(21) Appl. No.: 16/960,892

(22) PCT Filed: Jan. 12, 2018
(86) PCT No.: PCT/KR2018/000616

§ 371 Date: Jul. 9, 2020

(30) Foreign Application Priority Data
Jan. 11, 2018 (KR) 10-2018-0003659

(51) Int. Cl. A61C 5/55

(52) U.S. Cl. CPC A61C 5/55

(57) ABSTRACT

An apparatus for filling a root canal. The apparatus is connected to a filling material melting unit and transfers vibration generated from the filling material melting unit or heat to a first filler or a second filler for filling a root canal. The apparatus includes: a connecting part connected with the filling material melting unit; a contact part being in contact with and pressing the first filler or the second filler to make the root canal be filled with the first filler; and a transferring part that mediates the connecting part and the contact part to transfer heat or vibration provided from the filling material melting unit to the contact part through the connecting part. The contact part includes: a first contact part having a first taper ratio and a second contact part having a second taper ratio that is equal to or larger than the first taper ratio.

### TECHNICAL FIELD

The present invention relates to an apparatus for filling a root canal, and particularly, to an apparatus for filling a root canal which fills a root canal in which damaged or contaminated pulp is removed with a filler.

### BACKGROUND ART

In general, as a method of treating cavities in a dental clinic, a rotten portion of a tooth is removed by using a perforating device, when a pulp is damaged, the damaged or contaminated pulp is removed, and then a root canal that is a treatment portion is filled with a filler and is sealed to perform prosthetics.

Herein, when the root canal is filled, gutta percha cone and a sealer for filling a root canal (root canal sealer) are used as a permanent filling material that allows the filler to penetrate the root canal and completely seal the root canal.

Gutta percha is a natural vegetable extract and is a semi-solid state at a room temperature, but may be provided in the form of a solidified rubber by applying a pressure or heat. Wax, pigment, and the like are added to the gutta percha and combined in a roller or a blender, and the mixed gutta percha is pulled out in a plate shape and then is cut into a conical shape for each size. The gutta percha cone manufactured as described above is the most widely used material today in filling the root canal, and is most suitable for living organisms because the gutta percha cone has little toxicity to a root apex. Currently commercially available gutta percha cones consist of standardized cones, non-standardized cones, and accessory cones.

The root canal sealer, which is viscous ointment-type dental cement, is coagulated after several hours after being applied into the root canal and changed into a stable phase of bio-inertness to maintain continuous sealing performance. Since the gutta percha along cannot be expected to seal even the details of an accessory root canal and a main root canal, sealing force needs to be secured by applying the root canal sealer together when the gutta percha fills the root canal.

In the treatment of the root canal, after the infected nerve tissue and the like are removed by perforating a pulp infected portion with a perforating device, a root canal sealer is applied onto a wall of the root canal so that no more infectious source is generated in the root canal, and a gutta percha cone of an appropriate size is inserted into the root canal to fix the filler in the root canal. In this case, it is important to ensure that the gutta percha cone is completely in tight contact with the wall of the root canal and the apex side and a sufficient amount of root canal sealer needs to be applied.

As a device for filling a root canal with a filler inserted into a root canal, Korean Patent No. 1138839 discloses a root canal filling device for dental clinic, which is not to use the commonly used gutta percha and root canal sealer, but is a device for applying a root canal filler of a special material into the root canal.

For reference, in the related art, the root canal filling method includes various technologies, but may be basically divided into a non-heating lateral pressing method and a vertical pressing method. The non-heating lateral pressing method has the advantage of being able to control a position of gutta percha in a root canal, but there are problems in that a procedure is difficult, the procedure takes a long time, a space between the gutta percha is not homogeneous, the suitability of the root canal sealer on an inner wall of the root canal deteriorates, and a root of a tooth may be vertically cracked.

In the meantime, the vertical pressing method is a method of filling a root canal by applying heat to the gutta percha and joining the gutta percha to a root canal wall, and in the method, gutta percha coated with a root canal sealer is inserted into a root canal, a predetermined part of the gutta percha is cut by using a heated vertical pressing pen, a root apex of the root canal is sealed by pressing the gutta percha together with applying heat, the remaining root canal is blocked with the softened gutta percha by using a gun for injection, and then the gutta percha is pressed and compacted with a separate condenser. In this process, it is necessary to apply a heating device up to the very deep portion of the root canal in order to apply heat to the gutta percha, so that there are disadvantages that thermal damage may be caused to tissues around the tooth, an operation time is long, there is inconvenience that the procedure requires to go through several stages, expensive equipment needs to be required, and there is a high risk of overfilling by vertical pressing force.

However, in the foregoing vertical pressing method, when a tip for thermal pressing is used, high heat of about 200° is generated by itself for softening the gutta percha, so that there is a risk of burns and damage to a periodontal membrane of the root of a tooth, and a size of the used gun for injection itself is also large, thereby making it difficult to secure a field of view for the procedure.

Further, the tip for applying heat and the gun for injection are expensive, the maintenance cost thereof is also high because high heat must be generated, and in case of failure or breakage, the cost of repair is also high.

In addition, since an operation of compacting the gutta percha by using a separate condenser again before the gutta percha is hardened and cleaning an entrance of the root canal is required after the root canal is completely blocked by using the gun for injection, so that there is a problem in that the procedure is inconvenient.

### DISCLOSURE

### Technical Problem

An object of the present invention is to provide an apparatus for filling a root canal, which, in the case where a main root canal and an accessory root canal, in which a pulp is removed, are filled with a root canal sealer in a method of filling a root canal by using a vertical pressing method, improves filling efficiency of the sealer even in the detailed portions of the accessory root canal and the main root canal, protects patients from a risk of thermal damage to the tissues around a tooth and overfilling incurable when the existing vertical pressing method is applied, and provides an operator with operation convenience.

### Technical Solution

The present invention provides an apparatus for filling a root canal, which is connected with a filling material melting unit driven by a power supply and transfers vibration generated from the filling material melting unit or heat generated by the vibration to a first filler or a second filler filling a root canal, the root canal including a main root canal in which the pulp is removed and an accessory root canal branched from the main root canal, to allow the main root canal and the accessory root canal of the root canal to be filled with the first filler, the apparatus including: a connecting part connected with the filling material melting unit; a contact part which is in contact with and presses the first filler or the second filler, which has been injected into the main root canal, to make the main root canal or the accessory root canal be filled with the first filler; and a transferring part which mediates the connecting part and the contact part to transfer heat or vibration provided from the filling material melting unit to the contact part through the connecting part.

The contact part includes: a first contact part formed to have a first taper ratio in a direction from an end side to the transferring part; and a second contact part formed to have a second taper ratio that is equal to the first taper ratio or relatively larger than the first taper ratio from the first contact part to the transferring part.

Further, the second contact part may be indicated with a marking part of a predetermined thickness so as to be adjacent to a boundary with the transferring part.

Further, the apparatus may further include a second marking part formed at a predetermined interval from the first marking part toward the second contact part.

Further, a taper ratio of each portion of the contact part may be formed in a range of 0 to 0.1.

Further, the contact part may be formed in a length of 1 mm to 8 mm.

Further, the contact part may be formed in a circular shape of which a diameter of a cross-sectional area of a distal end is 0.40 mm to 1.40 mm.

Further, an end of the contact part may be formed in a plane.

Further, the transferring part may include: a first transferring part connected with the contact part and formed in a second length; and a second transferring part connected with the transferring part, having the other side connected with the connecting part, and formed in a third length, and a virtual first straight line extending an axis of the first transferring part and a virtual second straight line extending an axis of the second transferring part may form a first angle in a range of 60 to 120°.

Further, the transferring part may be formed to have a second taper ratio such that a diameter increases from the contact part to the second transferring part.

Further, the second taper ratio may be 0.02 to 0.10.

Further, the second length may be formed in a range of 12 mm to 25 mm.

Further, the second straight line and a virtual third straight line extending an axis of the connecting part may form a second angle in a range of 90 to 180°.

Further, the second filler formed in a shape corresponding to a shape of the main root canal may be inserted into the main root canal, and in a state where the first filler fills a space other than a filling space of the second filler in the main root canal, the contact part may soften at least a part of the second filler by heat of a first temperature transferred from the transferring part.

Further, the first contact part may press a surface layer of the second filler that is being hardened in a state where the filling material melting unit is off to make the accessory root canal be filled with the first filler in the softened state.

### Advantageous Effects

The apparatus for filling the root canal of the present invention may improve filling efficiency of gutta percha and the root canal sealer in the main root canal and the accessory root canal.

Further, it is possible to protect patients from a risk of thermal damage to the tissues around a tooth and overfilling incurable when an existing vertical pressing method is applied.

Further, it is possible to enable an operator to secure a field of view, simply a technique, and provide procedure convenience when the operator fills a root canal of a patient with a filler.

Further, the apparatus for filling the root canal of the present invention is compatible with an existing scaling ultrasonic wave generating device, so that separate auxiliary cost is not required to reduce cost.

### DESCRIPTION OF DRAWINGS

FIG. 1 is a schematic perspective view illustrating an ultrasonic wave generating device mounted with an apparatus for filling a root canal according to an exemplary embodiment of the present invention.

FIG. 2 is a schematic perspective view illustrating an apparatus for filling a root canal according to an exemplary embodiment of the present invention.

FIG. 3 is a front view illustrating the apparatus for filling the root canal according to the exemplary embodiment of the present invention.

FIG. 4 is a schematic diagram illustrating a transferring part of the apparatus for filling the root canal according to the exemplary embodiment of the present invention.

FIG. 5 is a schematic diagram illustrating a connecting part of the apparatus for filling the root canal according to the exemplary embodiment of the present invention.

FIGS. 6 to 11 are schematic diagrams illustrating a method of filling a root canal according to an exemplary embodiment of the present invention.

### BEST MODE

Hereinafter, an exemplary embodiment of the present invention will be described with reference to the accompanying drawings. In the absence of specific definitions or references, terms indicating directions used in this description are based on the conditions indicated in the drawings. Further, like reference numerals designate like elements in each exemplary embodiment. In the meantime, in the drawings, for ease of description, a thickness or a size of each configuration may be exaggerated, and it does not mean that the present invention should be actually configured with an corresponding size or a ratio between the configurations. However, the spirit of the present invention is not limited to the presented exemplary embodiment, and those skilled in the art understanding the spirit of the present invention may easily suggest other degrading inventions or other embodiments included in the scope of the spirit of the present invention by adding, changing, or deleting other components within the scope of the same spirit, but other embodiments are considered to be included in the scope of the spirit of the present invention.

An apparatus for filling a root canal of the present invention is an apparatus for filling a main root canal and an accessory root canal, in which a pulp is removed, with gutta percha and a root canal sealer when a procedure according to a vertical pressing method among the root canal filling methods is performed.

In general, a root canal sealer is inserted into a main root canal and an accessory root canal of a patient while being coated on gutta percha to be used for protecting the main root canal and the accessory root canal from moisture or foreign substances introduced from the outside.

The apparatus for filling the root canal of the present invention is an apparatus for improving filling efficiency of gutta percha and a sealer in a main root canal and an accessory root canal and providing procedure convenience when the main root canal and the accessory root canal, in which a pulp is removed, are filled with the gutta percha and the root canal sealer.

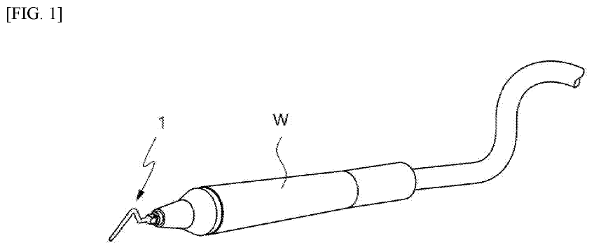

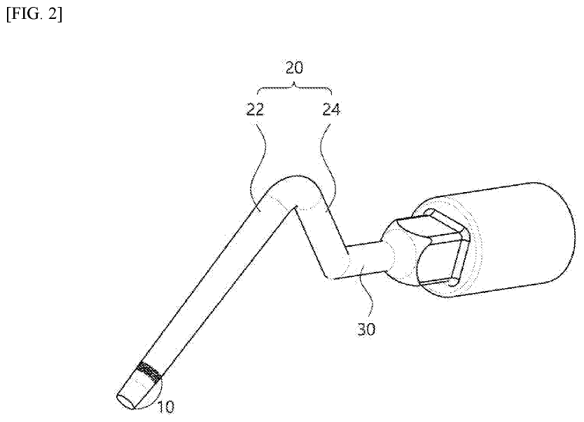

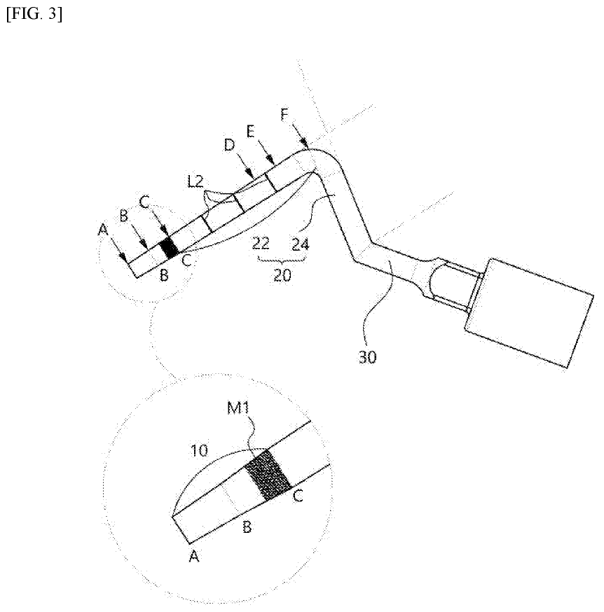

An apparatus 1 for filling a root canal according to an exemplary embodiment of the present invention will be described with reference to FIGS. 1 to 5. FIG. 1 is a schematic perspective view illustrating an ultrasonic wave generating device mounted with an apparatus for filling a root canal according to an exemplary embodiment of the present invention, FIG. 2 is a schematic perspective view illustrating the apparatus for filling the root canal according to the exemplary embodiment of the present invention, and FIG. 3 is a front view illustrating the apparatus for filling the root canal according to the exemplary embodiment of the present invention.

Referring to FIGS. 1 to 3, the apparatus 1 for filling the root canal according to the exemplary embodiment of the present invention is connected with an ultrasonic wave generating device W which is driven by a power supply and transfers heat or vibrations provided from the ultrasonic wave generating device W to a filler filled in a root canal to enable the filler to be evenly distributed and filled in the root canal (a main root canal P and an accessory root canal Q). In this case, the ultrasonic wave generating device W may be replaced with a device which generates vibrations or generating heat. Hereinafter, for convenience of the description, the device for generating ultrasonic waves, vibrations, and heat is collectively called a filling material melting unit.

The filling material melting unit W may be a device used for general dental scaling to remove tartar on top of the tooth's surface-bonded epithelium. Herein, the filling material melting unit W may be a device of a new design that implements the same function as that of the device used for scaling.

Further, the filling material melting unit W may generally be obtained by using a piezoelectric element having piezoelectric properties, and when energy is applied to a piezoelectric element material, vibration corresponding to a characteristic value of the material itself constituting the element is generated, and the generated vibration is transferred as sound waves in the ultrasonic region band.

Particularly, when a piezoelectric element is formed thin enough to obtain a desired frequency, electrodes are attached to both surfaces of the piezoelectric element, and then an alternating current voltage is applied at a frequency for a short time, deformation and restoration of the piezoelectric element are alternately incurred to generate vibrational energy, so that ultrasonic waves having a certain frequency are generated and heat according to the vibrational energy is accompanied.

The apparatus 1 for filling the root canal of the present invention includes a connecting part 30, a contact part 10, and a transferring part 20.

The connecting part 30 is connected with the filling material melting unit W, and may be manufactured in various forms according to a connection structure with the filling material melting unit W.

The contact part 10 is in contact with and presses a first filler S or a second filler G injected into the main root canal P to allow the main root canal P and the accessory root canal Q to be filled with the first filler S.

The transferring part 20 mediates the connecting part 30 and the contact part 10, that is, is disposed between the connecting part 30 and the contact part 10, and transfers heat or vibrations provided from the filling material melting unit W to the contact part 10 through the connecting part 30.

In this case, the transferring unit 20 has a figurative feature between the connecting part 30 and the contact part 10 in order to stably and efficiently transfer heat or vibrations to the contact part 10 through the connecting part 30 and simultaneously efficiently transfer the function to a treatment region in the oral cavity.

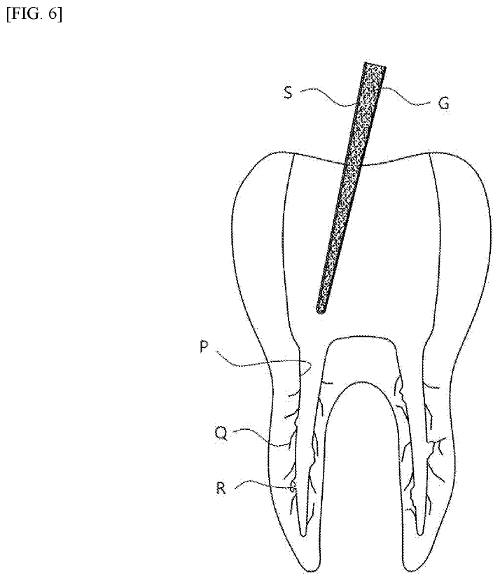

Referring to FIG. 3, the contact part 10 of the apparatus 1 for filling the root canal according to the exemplary embodiment of the present invention is in contact with the sealer (the first filler S and the second filler G, see FIG. 6) injected into the main root canal to help at least a part of the filling material to be softened through a heat of a first temperature transferred from the transferring part 20. Herein, the first temperature is the temperature at which the filling material (the first filler or the second filler) is softened, and particularly, the first temperature may be changed according to a composition ratio of the second filler, but may be preferably 40° C. to 200° C. When the existing vertical pressing method is applied, the device heated to the temperature is applied very deeply in the root canal, so there is a possibility of thermal damage to the tissue around the tooth, but the contact part of the present invention applies heat and vibrations from the outside around of the root canal entrance, thereby fundamentally blocking a possibility of the transferring higher temperature heat than necessary to the root of a tooth.

The contact part 10 may be divided into a first contact part from point A that is an end to point B, and a second contact part from point B and point C. Further, the transferring part 20 is divided into a first transferring part 20 and a second transferring part 24 according to an angle.

In the present exemplary embodiment, the contact part 10 and the transferring part 20 are formed to have distinctive lengths and gradients so as to implement the functions, respectively. Particularly, one of the main characteristics of the present invention is implemented by the length and the gradient of the contact part 10. This will be described in detail below.

First, a physical standard for each portion according to the exemplary embodiment will be described.

TABLE 1

| | A | B | C | D | E | F |
|---|---|---|---|---|---|---|
| Tip | 0.50 | 0.62 | 0.92 | 1.40 | 2.00 | 2.00 |

Table 1 represents diameters of the portions of the contact part 10 and the transferring part 20 according to the exemplary embodiment as illustrated in FIG. 3. A tip according to the exemplary embodiment of the present invention may be formed in various diameters according to the type or a size of the tooth. However, when a size of the tooth to be treated is large, the diameters at points A and B are formed to be relatively large, but the diameters at points E and F are formed to be the same, and the diameters at points C and D may be formed to have the gradients according to the diameters at points A and B.

However, these diameters may be formed within the range of about 10% of the upper and lower limits, respectively, considering intentional or unintentional errors.

TABLE 2

| | L-ab | L-bc | L-cd | L-de | L-ef |
|---|---|---|---|---|---|
| Length (mm) | 3 | 3 | 8 | 2 | 4 |

In Table 2, a length L-ab between point A and point B, a length L-bc between point B and point C, a length L-cd between point C and point D, a length L-de between point D and point E, and a length L-ef between point E and point F are expressed in millimeters.

The tips according to the present exemplary embodiment were formed to have the same length to each point. However, considering the intentional or unintentional error, the lengths may be formed in a range of about 10% of the upper and lower limits, respectively.

Further, in another aspect, a length of the contact part 10, that is, a distance L1 from point A to point C is the optimum length, to be inserted for hydrodynamic pressure generation in the portion of the root canal entrance, and the length may be a length calculated based on the statistical length of the root canal of the permanent tooth. That is, when the first length L1 is less than 1 mm, it is difficult to perform the function of the condenser for the finish operation. Further, when the first length L1 is larger than 8 mm, it is difficult to form a gradient, that is, a taper ratio, of the contact part in accordance with the shape in the root canal.

According to another aspect, the length of the first transferring part 22 may be 12 mm to 25 mm. Here, the length of the first transferring part 22 is a physical standard for providing a space for the operator to secure a field of view for treatment and to perform a sophisticated operation smoothly during the procedure when the operator performs the procedure on the root canal to be treated, together with the taper ratio of the first transferring unit 22. The length and the taper ratio of the first transferring part 22 may be calculated based on the statistical oral structure size.

TABLE 3

| | D-ab | D-bc | D-cd | D-de | D-ef |
|---|---|---|---|---|---|
| Tip | 0.04 | 0.10 | 0.06 | | — |

Table 3 represents the gradient for each section calculated from Tables 1 and 2. For example, a gradient per unit length between point A and point B, that is, a taper ratio, is expressed by D-ab. In the standards, particularly, the taper ratio of the contact part 10, that is, a taper ratio D-ab of the first contact part and a taper ratio D-bc of the second contact part have particular significance. The first contact part 10_AB is formed to have a gradient of 0% or 4%, so that the first contact part is formed to have a very small gradient compared to other parts, that is, formed in a shape close to a cylinder, and the second contact part 10_BC is formed to have a gradient of about 4% or 10%, so that the second contact part is formed to emphasize a function, such as a piston, which will be described below. That is, the first contact part and the second contact part may also be formed to have the same gradient, but it is more preferable to separately form the gradient by dividing the contact part 10 into the first contact part and the second contact part.

Since the diameter of the end side of each tip is different and the upper limit of the gradient of the contact part 10 and the diameter of point F are determined, the gradient of the first transferring part 22 from portion C to portion F for each tip is approximately in inverse proportion to the diameter of the end A. Further, the gradient of each portion to each of points D, E, and F of each tip needs to be formed so as not to be excessive.

According to another aspect, the taper ratio specifically represents a ratio of change in the diameter according to the change in length of 1 mm, and a first taper ratio represents an increase or decrease ratio of the diameter compared to a 1 mm length change of the contact part 10, and the first taper ratio may be formed in the range of 0.00 to 0.10 in each portion of the contact part 10 and the transferring part 20. In this case, the taper ratio of 0 means a cylindrical or polygonal cylinder shape with no change in thickness per unit length.

In this case, the taper ratio of 0.00 means that the contact part 10 is formed in a cylindrical shape. In this case, it may be considered that the contact part faithfully serves as the condenser, but there is a disadvantage in terms of performing a function as a piston according to the shape in the root canal. In the meantime, when the gradient, that is, the first taper ratio, of the contact part 10 is equal to or larger than 0.10, it is difficult to insert the contact part into the root canal.

In the meantime, when the contact part 10 is excessively thin, particularly, an area of the end of the contact part 10 is excessively small, the surface area of the pressure caused by vibration transferred from the transferring unit 20 or external force is reduced and the pressure is concentrated, so that the contact part 10 may crush or penetrate the hardened second filler G, and when the contact part 10 is excessively thick, it is difficult to insert the contact part into the root canal, and thus the contact part 10 may not be in contact with the second filler G. This is the difference from the existing scaling device and the like. That is, a simple scaling device does not press a filler like a piston, so that a cross-sectional area needs not to be more than a certain level. However, the apparatus for filling the root canal according to the present exemplary embodiment presses the surface of the hardened filler and fills the main root canal and the accessory root canal with the filler in the softened state, so that the cross-sectional area needs to be formed to have a predetermined area or more, and the end needs not to be sharply formed, and a flatness needs to be a predetermined level or more.

The distal end of the contact part 10 may be formed in a circular plane or a curved surface close to the plane. The end of the contact part 10 is formed in the plane as described above, so that it is possible to perform a finish operation of compacting the filler in the root canal and a finish operation of scraping off contamination at the root canal entrance, which are performed by using the existing condenser after filling the root canal with the filler.

In the meantime, a first marking part M1 may be formed to be adjacent to point C of the second contact part 10. The first marking part M1 is formed to have a predetermined thickness, preferably, about 1 mm, from point C to point B by using a laser marking method and the like. The first marking part M1 helps an operator to intuitively determine the depth at which the contact part 10 is inserted in the process of filling the root canal, the depth at which the contact part 10 is immersed into the sealer in the process of pressing the sealer and the like, and the like.

Further, at least one second marking part L2 may be formed at every predetermined length, preferably, every about 3 mm, from the first marking part M1. The second marking part L2 enables the operator to intuitively make a determination in the oral cavity in the process of filling the root canal and is formed by a laser marking method and the like for improving operation easiness, similar to the first marking part M1.

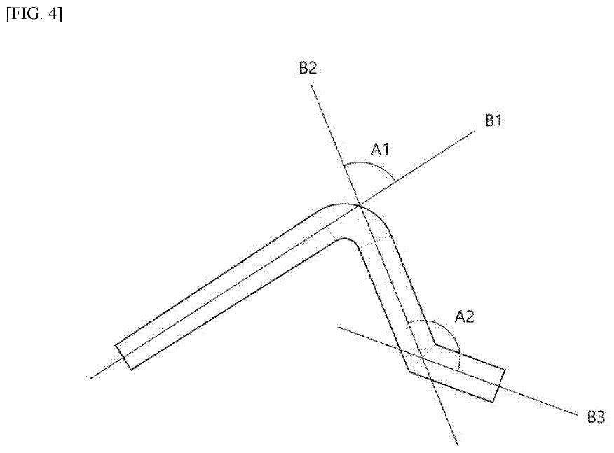

Referring to FIG. 4, a virtual first straight line B1 extending the axis of the first transferring part 22 and a virtual second straight line B2 extending the axis of the second transferring part 24 form a first angle A1. The second straight line B2 and a virtual third straight line B3 extending the axis of the connecting part 30 form a second angle A2. The first angle A1 and the second angle A2 may be formed in appropriate sizes based on the statistical size and structure of the oral structure. The first angle A1 may be formed in the range of 60° to 120°, and the second angle A2 may be formed in the range of 90° to 180°. For example, when the second angle A2 is formed in 180°, there may be a problem in that a doctor excessively twists the wrist during the oral treatment.

Further, the figurative characteristics of the first transferring unit 22, the second transferring unit 24, and the connecting part 30 are for the purpose of securing strength by heat or force, securing a field of view of an operator, and providing procedure convenience during the procedure of filling the root canal by using the apparatus 1 for filling the root canal, and particularly, the first angle A1 formed by the first transferring part 22 and the second transferring part 24 and the second angle A2 formed by the second transferring part 24 and the connecting part 30 may provide appropriate elasticity and strength to transverse pressure applied from the operator or the filling material melting unit W during the procedure process.

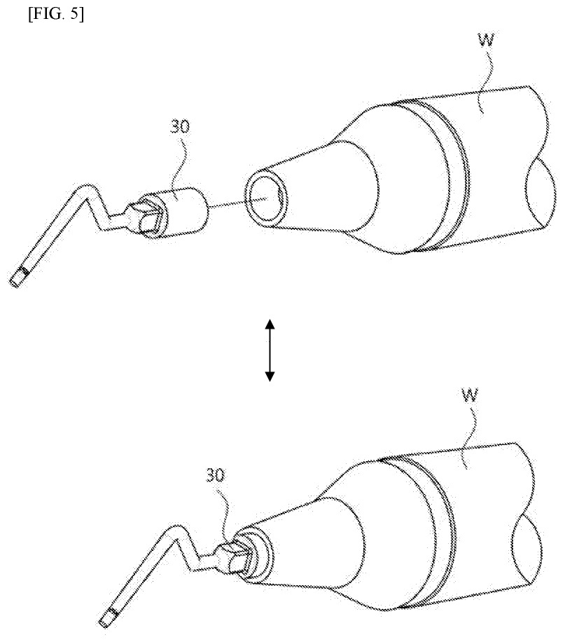

FIG. 5 is a schematic diagram illustrating the connecting part of the apparatus for filling the root canal according to the exemplary embodiment of the present invention.

Referring to FIG. 5, the connecting part 30 may be fastened to the filling material melting unit W while a distal end of the connecting part 30 is inserted into the filling material melting unit W. FIG. 5 corresponds to the exemplary embodiment for showing the combination relation between the connecting part 30 and the filling material melting unit W, so that the present invention is not limited to the shape of FIG. 5. The distal end of the connecting part 30 may be changed into various forms according to the fastening structure with the filling material melting unit W.

FIGS. 6 to 11 are schematic diagrams illustrating a method of filling a root canal according to an exemplary embodiment of the present invention. The method of filling a root canal according to the exemplary embodiment of the present invention is a procedure method by the apparatus 1 for filling the root canal described with reference to FIGS. 1 to 5.

Referring to FIG. 6, a root canal, in which a pulp is removed, is prepared by perforating a pulp infection region by using a perforating device (not illustrated) and the like and removing the infected nerve tissue and the like.

In the meantime, the root canal, in which the pulp is removed, may be generally divided into a main root canal P and an accessory root canal Q, and the main root canal P means an anatomical space in the central portion of the root of a tooth, and in the main root canal P, an ecological variation region R may be differently formed for each individual by genetic and environmental factors. The accessory root canal Q means the root canal in the form of twigs branched from the main root canal P, and the number and the form of the accessory root canal Q are various for each individual.

A filler filled in the root canal may be divided into a first filler S and a second filler G, and the first filler S may include at least one component between a root canal sealer or a root canal filler cement, and the second filler G may be formed of an insoluble material including at least one component of gutta percha, zinc oxide, and barium sulfate. Further, the second filler G is hard and in a solid state having no elasticity at a room temperature.

Herein, the first filler S and the second filler G may also be identically made of a material including at least one component between the root canal sealer and the root canal filling cement.

In the meantime, the root canal sealer that is the first filler S is filled so that the walls of the main root canal P and the accessory root canal Q are covered to prevent moisture or foreign substances from penetrating into the root canal.

The second filler G is formed in a shape corresponding to the shape of the main root canal P. Particularly, the second filler G is not necessarily matched with the shape of the main root canal P, but is manufactured to be able to reach the bottom of the main root canal P and a part of the wall of the main root canal P. Herein, the first filler S may be coated on an external surface of the second filler G, and the first filler S may also be independently injected into the root canal.

Particularly, the second filler G that is in contact with the contact part 10 of a first temperature is softened, and the first filler S that is in a state of being in contact with the second filler G is also softened. In this case, at least a part of the first filler S coated on the external surface of the second filler G is introduced into the accessory root canal Q branched from the main root canal P.

Further, the contact part 10 is in contact with at least a part of the second filler G hardened by the release from the contact with the second filler G and presses the second filler G by vibration transmitted from the transferring unit 20 or external force.

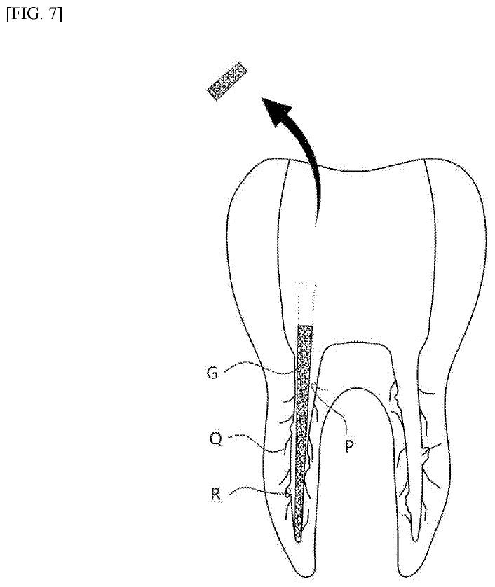

Referring to FIG. 7, the second filler G coated with the first filler S is injected into the main root canal P so that no more sources of injection are generated in the root canal in which the pulp is removed. In this case, the second filler G in the solid state may be pre-manufactured in a shape corresponding to a shape of the root canal in which the pulp is removed. Further, a part of the second filler G exposed to the outside is removed so that the second filler G injected into the main root canal P does not protrude too much from the entrance of the main root canal P.

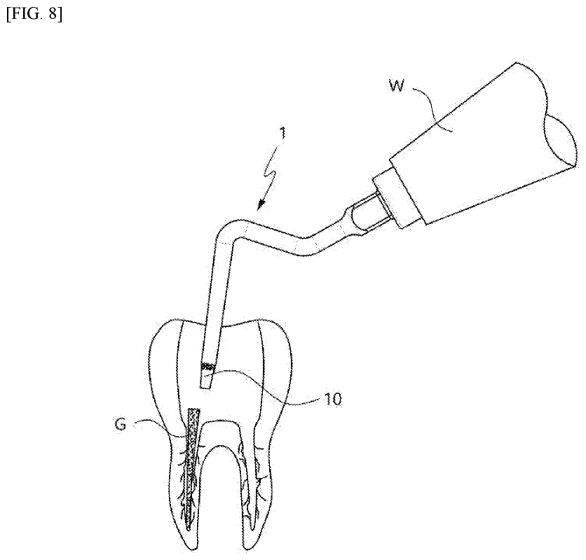

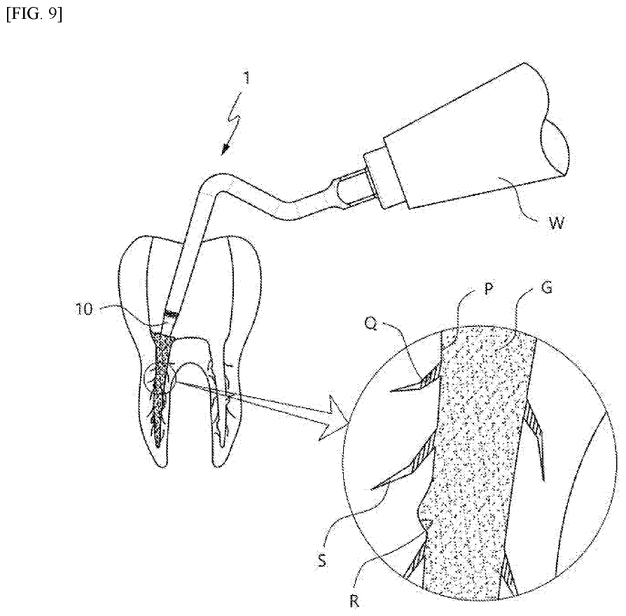

Referring to FIGS. 8 and 9, the contact part 10 of the apparatus 1 for filling the root canal is in contact with the second filler G of which a predetermined portion protrudes from the entrance of the main root canal P. In this case, the contact part 10 softens the second filler G or the first filler S of which the surface is hardened by ultrasonic vibration and heat provided from the ultrasonic wave generating device W.

Herein, the ultrasonic vibration and heat transferred through the second filler G scatters and softens the first filler S and the second filler G filled in the parts of the main root canal P and the accessory root canal Q, so that the part of the first filler S injected into the main root canal P and the accessory root canal Q is introduced into the accessory root canal Q and the fine accessory root canal Q in the form of twigs branched from the accessory root canal Q. Further, the first filler S is also introduced into the main root canal P in which ecological variation R sites are presented by genetic and environmental factors.

Since the existing vertical pressing method softens and presses the second filler G in a very deep region of the root canal, excessive pressure that cannot be adjusted is generated and thus the softened second filler G is pushed out to the apex portion of the root of the tooth of the main root canal, so that there is risk that the second filler G is overfilled in tissues around the tooth. However, the present invention softens only a part of the second filler G at the entrance of the root canal and presses only the part of the second filler G, so that it is possible to block the generation of the excessive pressure in the root apex portion of the root of the tooth, thereby fundamentally preventing risk of overfilling.

Further, in contrast to the existing vertical pressing method which requires inserting a high-temperature instrument to the deep portion of the root canal and using various additional instruments, in the present invention, heating, pressing, and the finish operation are performed with only one device at the entrance of the root canal, so that the procedure time is very short, additionally required instruments may be excluded, thereby greatly improving the convenience of the procedure.

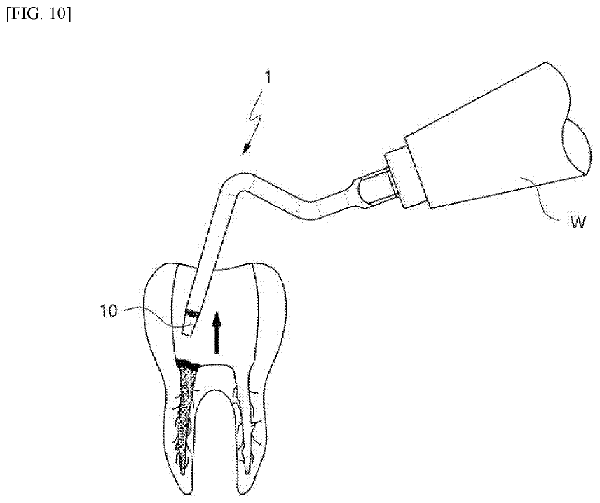

Referring to FIG. 10, the contact part 10 that had been in contact with the second filler G is released from the contact with the second filler G and cooled at a room temperature for a predetermined time. In this case, an upper portion of the second filler G is partially hardened in the state of being exposed to the outside.

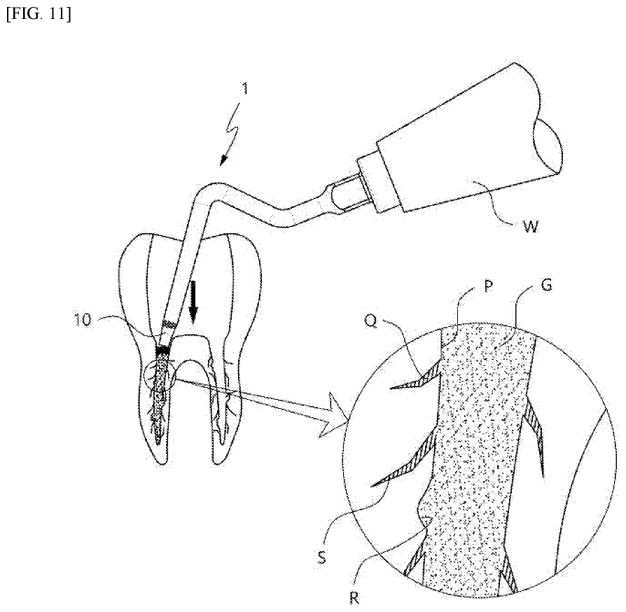

Next, as illustrated in FIG. 11, when it is determined that the second filler G exposed at the entrance side of the main root canal P is hardened, the contact part 10 is made to be in contact with the hardened second filler G to press the second filler G in a direction of the internal side of the main root canal P. Herein, the press of the second filler G may be implemented by vibration according to the driving of the filling material melting unit W, or may be implemented by external force of an operator without driving the filling material melting unit W.

In this case, the first contact part of the end is in direct contact with the second filler G to transfer pressing force, and the second contact part having a relatively large gradient compared to the first contact part is in contact with the inner wall of the main root canal more tightly during the pressing process to function as a piston of a syringe. By the function, the contact part acts so that the sealer including the second filler G is injected to a fine region.

In the case where only the first filler S is injected into the main root canal P without the insertion of the second filler G, a surface of the hardened second filler G may be pressed by using the contact part 10 in the state where the surface of the second filler G is hardened.

The second filler G moves to the internal side of the main root canal P while closing the entrance of the main root canal P by the external force applied to the hardened second filler G, and in this case, the first filler S and the second filler G which have not yet been hardened and are in the softened state are pushed into the internal side of the main root canal P by the hardened second filler G.

In this case, the first filler S is pushed into the space provided by the accessory root canal Q to be in contact with the wall of the accessory root canal Q tightly, and further, penetrates into and is located in the tightly contacting accessory root canal Q which is branched from the accessory root canal Q and in the form of twigs.

To sum up, the second filler G, which is in contact with the contact part 10 of the first temperature and is softened, starts to be hardened by the release from the contact with the contact part 10, and the hardening starts from the externally exposed portion of the second filler G that is in contact with external air.

In this case, when the contact part 10 presses at least a part of the hardened second filler G, the hardened portion of the second filler G is pushed into and enters the internal side of the main root canal P, which allows the second filler G and the first filler S, which have not yet been hardened, to be pushed into the main root canal P and the accessory root canal Q regardless of the shapes of the main root canal P and the accessory root canal Q. That is, at least a part of the hardened second filler G serves as a sort of piston that pushes the first filler S and the second filler G which are in the softened state into the internal side of the root canal.

Herein, the contact part 10 may press at least a part of the second filler G that is in the hardened state by the vibration transferred from the transferring part 20, or may press at least a part of the second filler G that is in the hardened state by external force of an operator in the state where the driving of the filling material melting unit W is stopped. As a matter of course, the contact part 10 may press at least a part of the second filler G that is in the hardened state by simultaneously applying the vibration transferred from the transferring part 20 and external force of an operator.

By the pressure applied to at least the part of the hardened second filler G, the first filler S filled in the parts of the main root canal P and the accessory root canal Q fills up the distal end of the accessory root canal Q branched from the accessory root canal Q and in the form of twigs, or an irregular space formed by the ecological variation R of the main root canal P.

Further, at least the part of the second filler G hardened by the release from the contact of the contact part 10 is pressed while the first filler S and the second filler G in the softened state are blocked from flowing out, so that the first filler S in the softened state fills the accessory root canal Q without flowing out.

The second filler G in the softened state moves so as to seal the entrance of the main root canal P by attachment force on the wall of the root canal or gravity, is hardened in the state where the entrance is sealed, and then the second filler G hardened in the form of sealing the entrance moves into the main root canal P smaller than the entrance of the main root canal P to be in contact with the wall of the main root canal P more tightly, so that the first filler S or the second filler G in the softened state located at the lower side of the hardened second filler G does not flow out.

The first filler G in the softened state is pushed out by the hardened second filler G to fill the accessory root canal Q or the distal end of the accessory root canal Q branched from the accessory root canal Q and in the form of twigs.

In the method of filling the root canal of the present invention, the main root canal P, the accessory root canal Q, and the accessory root canal Q branched from the accessory root canal Q and in the form of twigs are filled with the first filler S (sealer) by using the apparatus 1 for filling the root canal, thereby preventing moisture or foreign substances from flowing into the root canal in which the pulp is removed.

Further, the method of filling the root canal is implemented by the apparatus 1 for filling the root canal described with reference to FIGS. 1 to 5, so that the contents of the method of filling the root are applicable to the description of the apparatus 1 for filling the root canal described with reference to FIGS. 1 to 5 for helping understanding as a matter of course.

Although the exemplary embodiment of the present invention has been described in detail, the technical spirit of the present invention is not limited by the embodiment, and various implementations may be made in the range without departing from the technical spirit of the present invention embodied specified in the claims.

1. An apparatus for filling a root canal, which is connected with a filling material melting unit driven by a power supply and transfers vibration generated from the filling material melting unit or heat generated by the vibration to a first filler or a second filler filling a root canal, the root canal including a main root canal in which the pulp is removed and an accessory root canal branched from the main root canal, to allow the main root canal and the accessory root canal of the root canal to be filled with the first filler, the apparatus comprising:
a connecting part connected with the filling material melting unit;
a contact part which is in contact with and presses the first filler or the second filler, which has been injected into the main root canal, to make the main root canal or the accessory root canal be filled with the first filler; and
a transferring part which mediates the connecting part and the contact part to transfer heat or vibration provided from the filling material melting unit to the contact part through the connecting part,
wherein the contact part includes:
a first contact part formed to have a first taper ratio in a direction from an end side to the transferring part; and
a second contact part formed to have a second taper ratio that is equal to the first taper ratio or relatively larger than the first taper ratio from the first contact part to the transferring part.

2. The apparatus of claim 1, wherein the second contact part is indicated with a marking part of a predetermined thickness so as to be adjacent to a boundary with the transferring part.

3. The apparatus of claim 2, further comprising:
a second marking part formed at a predetermined interval from the first marking part toward the second contact part.

4. The apparatus of claim 1, wherein a taper ratio of each portion of the contact part is formed in a range of 0 to 0.1.

5. The apparatus of claim 1, wherein the contact part is formed in a length of 1 mm to 8 mm.

6. The apparatus of claim 1, wherein the contact part is formed in a circular shape of which a diameter of a cross-sectional area of a distal end is 0.40 mm to 1.40 mm.

7. The apparatus of claim 1, wherein an end of the contact part is formed in a plane.

8. The apparatus of claim 1, wherein the transferring part includes:
a first transferring part connected with the contact part and formed in a second length; and
a second transferring part connected with the transferring part, having the other side connected with the connecting part, and formed in a third length, and
a virtual first straight line extending an axis of the first transferring part and a virtual second straight line extending an axis of the second transferring part form a first angle in a range of 60 to 120°.

9. The apparatus of claim 8, wherein the transferring part is formed to have a second taper ratio such that a diameter increases from the contact part to the second transferring part.

10. The apparatus of claim 9, wherein the second taper ratio is 0.02 to 0.10.

11. The apparatus of claim 8, wherein the second length is formed in a range of 12 mm to 25 mm.

12. The apparatus of claim 8, wherein the second straight line and a virtual third straight line extending an axis of the connecting part form a second angle in a range of 90 to 180°.

13. The apparatus of claim 1, wherein the second filler formed in a shape corresponding to a shape of the main root canal is inserted into the main root canal, and in a state where the first filler fills a space other than a filling space of the second filler in the main root canal, the contact part softens at least a part of the second filler by heat of a first temperature transferred from the transferring part.

14. The apparatus of claim 13, wherein the first contact part presses a surface layer of the second filler that is being hardened in a state where the filling material melting unit is off to make the accessory root canal be filled with the first filler in the softened state.
